(19) United States
(12) Patent Application Publication
(10) Pub. No.: US 2017/0136645 A1
(43) Pub. Date: May 18, 2017

(54) TUBE CUTTING and INSTALLATION TOOL

(71) Applicants: Jeffrey A. White, Avon Lake, OH (US); Theodore Bradley, North Ridgeville, OH (US); Gregg VanSuch, Stow, OH (US)

(72) Inventors: Jeffrey A. White, Avon Lake, OH (US); Theodore Bradley, North Ridgeville, OH (US); Gregg VanSuch, Stow, OH (US)

(21) Appl. No.: 15/054,991

(22) Filed: Feb. 26, 2016

Related U.S. Application Data
(63) Continuation of application No. 14/939,828, filed on Nov. 12, 2015, now abandoned.

(51) Int. Cl. B26D 3/16; B26B 29/02; B26B 5/00

(52) U.S. Cl. CPC B26D 3/169; B26B 5/006; B26B 29/02

(57) ABSTRACT

A tube cutting and installation tool having two semi-circular shaped open cutting heads for cutting different sizes of tube diameter and cut-outs for assisting with the installation of the cut tubes.

### CROSS REFERENCE TO RELATED APPLICATION

The present application claims priority from pending U.S. patent application Ser. No. 14/939,828 filed Nov. 12, 2015, which claims priority from U.S. Provisional Application Ser. No. 62/078,968 filed Nov. 12, 2014, the entire subject matters of which are incorporated herein.

### FIELD OF INVENTION

The present application is directed to a hand tool for cutting polymer tube, and more particularly to a tube cutting and installation tool having two heads for cutting multiple sizes of tube diameter and cut-outs for assisting with the installation of the cut tubes.

### BACKGROUND

Typical household plumbing fixtures include a P-trap or an S-trap installed under the sinks in bathrooms and kitchens, depending on local housing code requirements. There are multiple purposes for traps formed in P and S shaped plumbing fixtures. The looped pipes or traps contain debris that has drained from the sink and prevents it from forming a clog deeper within the plumbing system. They also serve to stop sewer gases from passing into the home by forming a water barrier within the trap. In current plumbing systems, waste drains and traps are made from a variety of different materials, but principally metal or polymers such as ABS (or acrylonitrile butadiene styrene) and PVC (or polyvinyl chloride) pipe.

Replacing or installing traps made of polymer pipe under a sink can be an awkward procedure, given space limitations. The pipe must first be cut to the desired lengths for proper interconnection, and then installed at the desired location. Also, two standard pipe diameters—1¼ inch for bathroom traps and 1½ inch for kitchen traps—frequently require cutting, potentially necessitating multiple tools or one for each pipe size. As a result, a single tool having several features to assist with both the cutting and installation of cut pipe having different diameters would be a useful tool to a plumber or homeowner.

Numerous prior art devices have attempted to provide solutions to the situation described above, including U.S. Pat. Nos. 7,743,509, 8,281,492, 7,716,840, 4,438,562, D626,812 and 4,368,577.

### SUMMARY

The tube cutting and installation tool is a hand tool including a tool body having a handle portion and cutting portion. The cutting portion includes at least two open cutting heads for engaging and cutting a 1.25 inch plastic pipe in one cutting head opening, and a 1.5 inch plastic pipe in another cutting head opening. The open cutting heads are positioned and arranged so that each of the two open cutting heads makes use of an opposite end or tip of a single standard trapezoidal shaped utility knife blade, where one tip is positioned such that it extends into an internal circumference within each of the open cutting heads. The blade is supported within a blade pocket or compartment within the tool body, and is removable from the tool body for replacement. A removable blade cover plate secures the blade within the tool body by conventional fasteners.

Each open cutting head enables the plastic pipe to be snapped into a semi-circular shaped opening, and into engagement with a blade tip. The hand tool or pipe may then be rotated to cut the pipe at the desired location into the desired lengths. When not in use, blade tip covers for the blade tips is provided which extends into the semi-circular openings for engagement with the open cutting head, and covers the blade tips to function as safety blade covers.

Spaced from the cutting heads toward the handle portion of the tool body, a cut-out is provided to assist with both removal and installation of the traps. Specifically, the cut-out is used to engage tabs extending from the pipe nuts which secure the interconnection of the pipes. Upon engagement of the pipe nut tabs within the cut-out, additional leverage for loosening or tightening the pipe nut is provided by rotation of the tube cutter hand tool body, as shown in the Figures provided. The hand tool body is designed with an I-beam configuration in cross-section, to provide the tool and handle with the necessary strength, but with a wider cross beam in the open cutting heads for engagement with the pipe. Finally, an opening is provided at the distal end of the tool handle portion for hanging the tool during storage.

### DESCRIPTION OF THE DRAWINGS

FIG. 1A and FIG. 1H are partial schematic bottom and top views, respectively, of the tube cutting and installation tool.

FIG. 1B is an exploded partial side view of the tube cutting and installation tool, with the blade and blade cover plate removed, and showing the blade tip covers pivoted out of the closed positions within the open cutting heads.

FIG. 1C is a side view of the blade cover plate removed from the tube cutting and installation tool.

FIG. 1D is a partial schematic rear end view of the tube cutting and installation tool.

FIGS. 1E and 1F are cross-sectional views of the tool body taken along the lines A-A and B-B, respectively, in the FIG. 1B view of the tube cutting and installation tool.

FIG. 1G is a partial schematic cut-away top view of the blade tip cover shown in FIG. 1B view of the tube cutting and installation tool.

FIG. 2 is a schematic side view of an alternate embodiment of the tube cutting and installation tool.

FIG. 3 is a schematic side view of another alternate embodiment along the lines of the embodiment of the tube cutting and installation tool of FIG. 2.

FIG. 4 is a partial side view of the tube cutting and installation tool demonstrating use of the installation aspect of the tool engaged with a pipe nut and the tabs of the pipe nut.

FIG. 5 is a schematic perspective side view of the alternate embodiment of the tube cutting and installation tool shown in FIG. 3, and with the blade cover plate removed.

FIG. 6 is another partial, schematic, cut-away side view of an alternate embodiment of the tube cutting and installation tool along the lines of FIG. 1B, and showing the blade engaged and covered by the blade cover plate, and showing the blade tips covered by the cut-away illustrations of the blade tip covers in closed positions within the open cutting heads.

FIG. 7 is another partial, schematic, cut-away side view of the alternate embodiment of the tube cutting and installation tool of FIG. 6, but showing the blade tips ready for engagement with a tube, and the cut-away illustrations of the blade tip covers rotated or pivoted to fully open positions away from the open cutting heads.

FIGS. 8 and 9 illustrate exploded perspective views of the blade tip covers of the tool shown in FIGS. 6 and 7, where the blade tip cover of FIG. 8 is associated with the open cutting head on the top of the tool, and the blade tip cover of FIG. 9 is associated with the open cutting head on the end of the tool opposite from the handle portion.

FIG. 10 is a cut-away top view of the cutting and installation tool of FIG. 6 with the blade tip covers in closed positions within the open cutting heads.

FIG. 11 is an enlarged, cut-away view of the highlighted section indicated in FIG. 10.

FIG. 12 is a partial, cut-away side view of a portion of the cutting portion of the tool body with the blade cover plate removed, along the lines of FIG. 6, and showing the blade pocket for engagement by the utility knife blade and blade cover plate.

FIG. 13 is a back side view of a portion of the blade cover plate shown along the lines of FIG. 6, and showing the blade pocket for engagement by the utility knife blade and blade cover plate.

### DETAILED DESCRIPTION

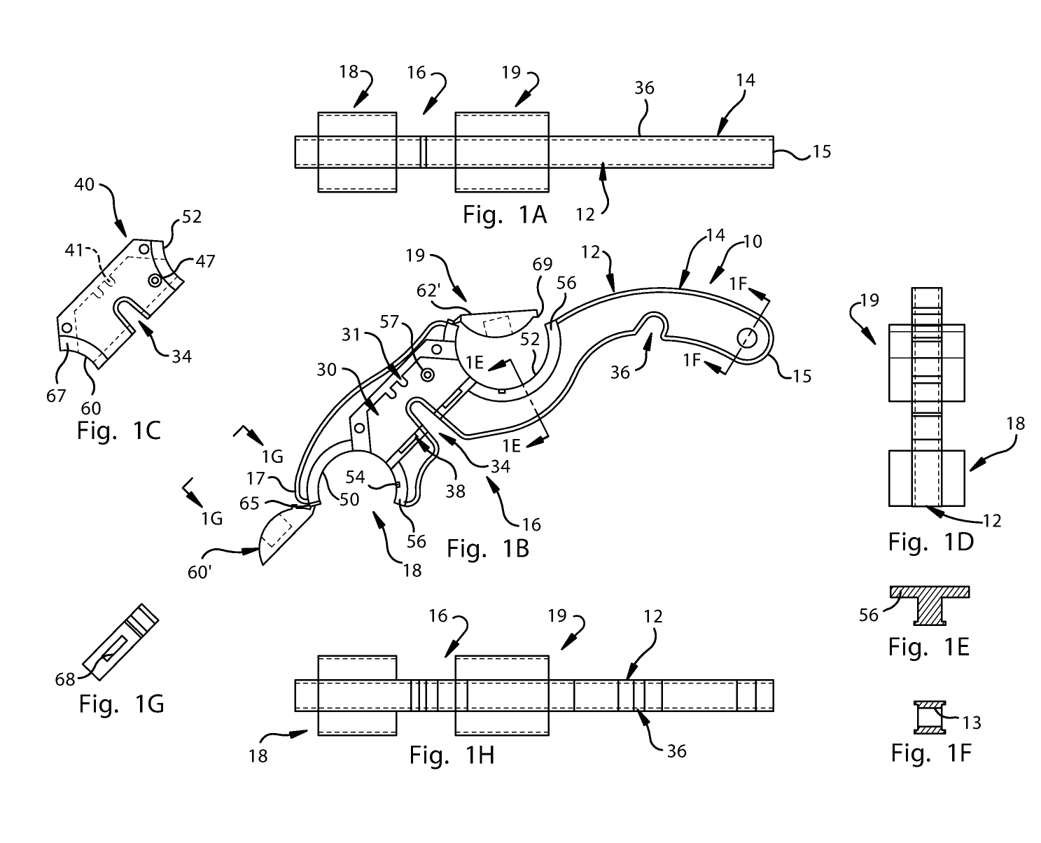

The present tube cutting and installation hand tool 10 includes an approximately 8 inch long tool body 12, and is illustrated in several embodiments, such as in FIGS. 1B, 2 and 6. The tool body 12 includes a handle portion 14 and a cutting portion 16. The cutting portion 16 has dual or at least two (2) open cutting heads 18, 19. The first open cutting head 18 is positioned on an end 17 of the tool body 12 opposite the handle portion 14.

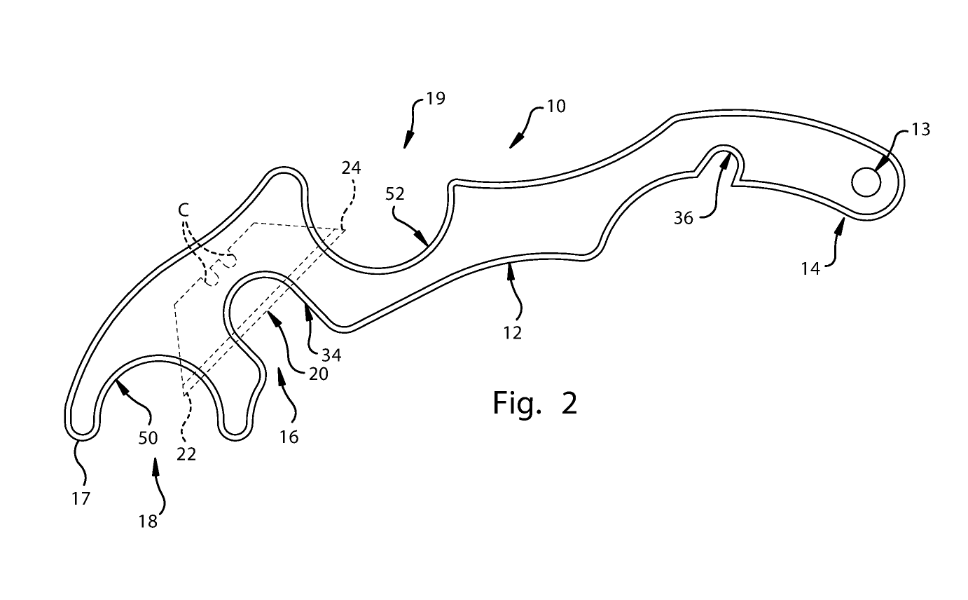

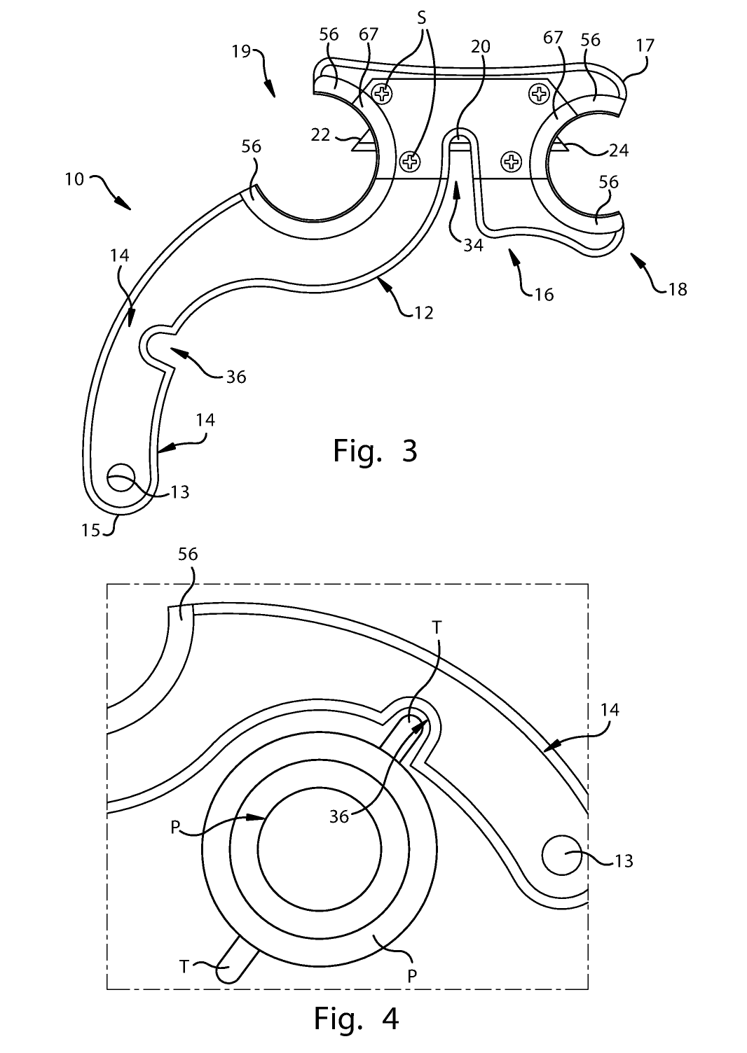

The first open cutting head 18 is configured for engaging the outer diameter of a 1.25 inch plastic pipe P. The second open cutting head is positioned intermediate the first open cutting head and the handle portion, and is configured for engaging the outer diameter of a 1.5 inch plastic pipe P. The arrangement of the cutting heads 18, 19 is designed so that each of the two cutting heads makes use of an opposite end or tip of a single standard trapezoidal shaped utility knife blade 20. When engaged within a blade pocket 30, formed in part within the cutting portion 16 of the tool body 12 and in part by a blade cover plate 40, one tip 22, 24 is positioned within each of the open cutting heads, as shown in FIGS. 2-3 and 6-7.

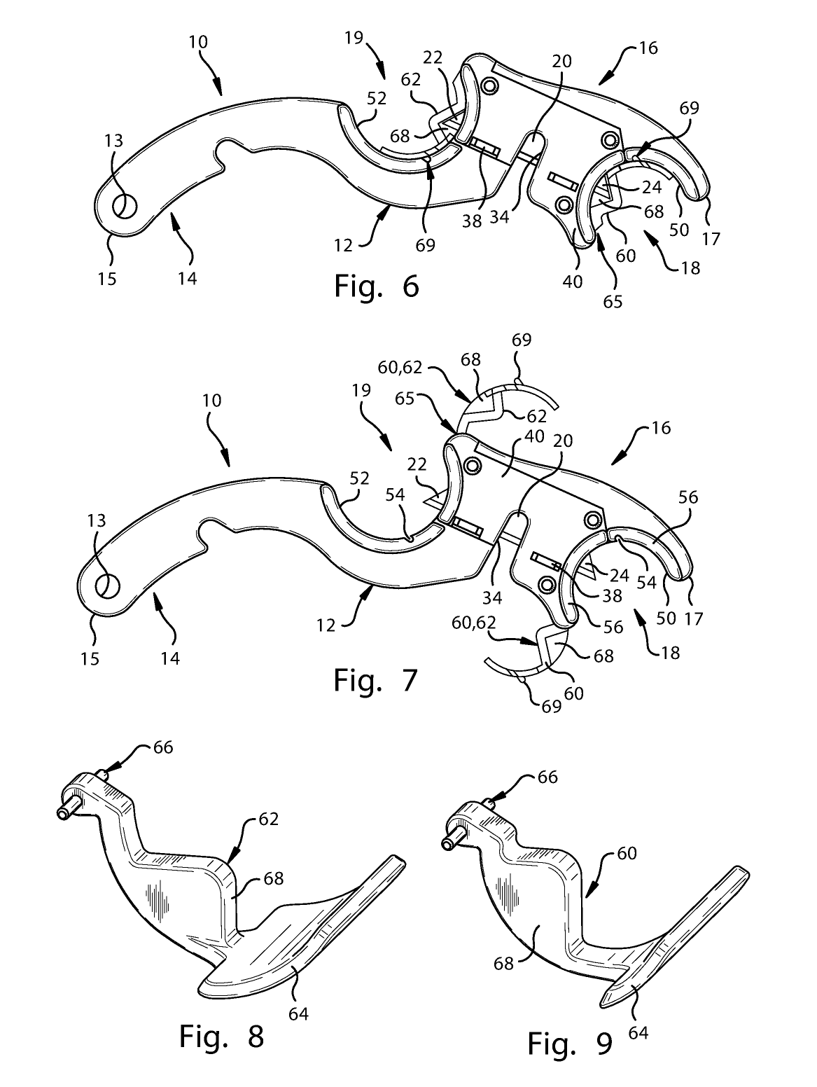

The blade 20 is supported within the blade pocket 30 or a compartment of the tool body 12, and removable from the tool body for replacement, by the blade cover plate 40 which is secured to the tool body 12 by conventional fasteners S. Both the blade pocket 30 of the tool body cutting portion 16 and the blade cover plate 40, include two raised U-shaped tabs 31, 41 for alignment and engagement with mating U-shaped cut-outs C provided on standard trapezoidal utility knife blades 20. Support posts 38 also extend from the cutting portion 16 of the tool body 12 for supporting a bottom surface of the standard trapezoidal utility knife blade, as shown in FIG. 12. Support post cut-outs 42 for engaging the support posts 38 are provided on the blade cover plate 40, shown in the illustration of the inside surface of the blade cover plate 40 in FIG. 13. The depth of the blade pocket 30 is preferably sufficient to receive and capture a standard utility knife blade 20 with the blade cover plate 40. In the embodiment of FIGS. 6 to 12, it is further pointed out that the blade cover plate 40, which extends to capture the pivot pins 66 of the blade tip covers 60, 62, also includes circular ribs 67, which extend out of the plane of the blade cover plate 40 to form a continued semi-circle adjacent the arc portion 56, as best shown in FIGS. 10 to 12. Aligned openings, at least four (4) in the illustrated embodiments, are provided in both the cutting portion 16 of the tool body 12 and blade cover plate 40 for receiving and securing the plate with conventional fasteners S. Further alignment portions 47, 57 may be provided to properly seat the knife blade 20 within the cutting portion 16.

A further cut-out 34, best shown in FIG. 2, may be provided on the tool body 12 and blade cover plate 40 adjacent a portion of the standard trapezoidal shaped utility knife blade 20 intermediate the tips 22, 24, such that a portion of the blade 20 is accessible and may be used for additional purposes such as cutting string or other cutting tasks. It should be understood that where alternative embodiments having similar elements are discussed, the similar elements may be designated with the same reference numeral, but with a prime designation.

Each open cutting head 18, 19 enables the plastic pipe P to be snapped into a semi-circular shaped opening 50, 52, respectively, formed by the tool body 12 and the blade cover plate 40, and into engagement with the blade tip 22, 24. The hand tool 10 or pipe P may then be rotated to cut the pipe P at the desired location into the desired lengths. When not in use, coverings for the blade tips 22, 24, as shown in FIGS. 2 and 6 to 11, are provided which extend into the semi-circular openings 50, 52 for engagement with the open cutting heads, 18, 19 and function as safety blade tip covers. The blade tip covers 60, 62 are pivotably secured or hinged to the tool at locations 65 adjacent to, but out of the way of, the semi-circular openings 50, 52, so that the safety blade tip covers are easily moved or rotated out of the way during a tube cutting operation, as in FIG. 7.

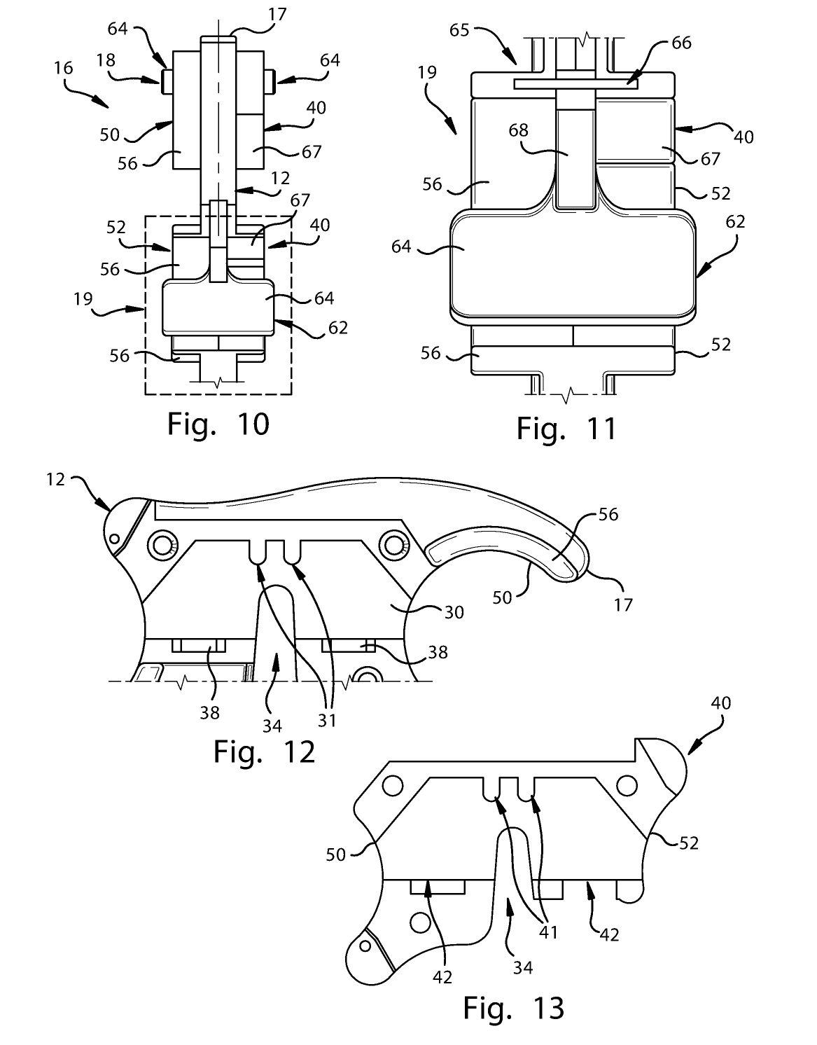

The blade tip covers 60, 62 and 60′, 62′ each include a tip housing 68 for covering the tip 22, 24 when in the closed position. The blade tip covers 60, 62 are retained within the semi-circular openings 50, 52 by a dimple 69 engaged by a friction fit within a depression 54 formed within the cutting head 18, 19. To move the blade tip covers 60, 62 out of the way, a finger tab portion 64 may be used which extends from the blade tip cover beyond the edge of the I-beam cross-sectional configuration, as shown in FIGS. 10 and 11, to be easily grabbed and moved by the user. Pivot pins 66 may be either press fit or molded into the blade tip covers 60, 62 which pins 66 are engaged and secured for rotation with respect to the tool body 12, as the pins 66 are in a position trapped or captured between the tool body 12 and the removable blade cover plate 40, as shown in FIGS. 6 to 13, and particularly in FIG. 11. In the embodiment of FIG. 1B, a living hinge formed integral with the tool body 12 to interconnect the blade tip covers 60′, 62′ may be provided.

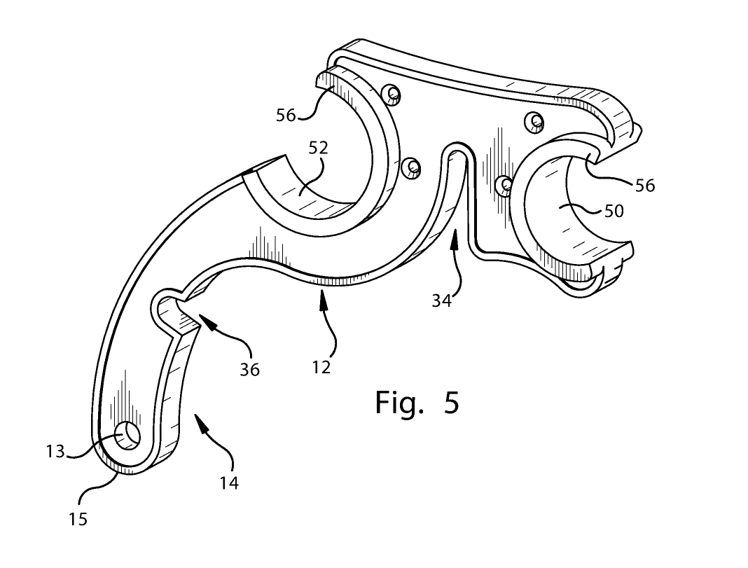

Spaced from the cutting heads 18, 19 toward a tool handle portion 14 of the tool body 12, a U-shaped cut-out 36 is provided to assist with both removal and installation of the traps. Specifically, the cut-out 36 is used to engage tabs T extending from the pipe nuts N which secure the interconnection of the pipes P. Upon engagement of the pipe nut tabs T within the cut-out 36, additional leverage for loosening or tightening the pipe nut N is provided by rotation of the tool body 12 using the handle portion 14, as shown in FIG. 4. The hand tool body 12 is designed with an I-beam configuration in cross-section, as shown in FIGS. 1E and 1F, to provide the tool 10 and handle portion 14 with the necessary strength and a for secure engagement of the tool 10 with the pipe P to be cut. It is noted that the arc portion 56 of the I-beam forming the semi-circular shaped openings 50, 52 has a wider cross portion of the I-beam configuration than the opposite cross portion of the I-beam, as shown in FIGS. 1E, 10 and 11. Finally, an opening 13 is provided at the distal end 15 of the tool handle portion 14 for hanging the tool 10 during storage.

The tube cutting and installation tool, and the tool body specifically, is preferably molded as a one piece polymer, such as of glass filled nylon, however, alternative appropriate polymer materials for the tool body and blade cover plate may also be used.

Although the exemplary embodiments have been described in detail with references and detail sufficient for one of ordinary skill in the art to practice the invention, it should be understood that various changes, substitutions and alterations may be made without departing from the spirit or scope of the device as defined in the attached claims. Moreover, the scope of the present device is not intended to be limited to the specific embodiments described here, which are provided by way of example. As one of ordinary skill in the art will readily appreciate from the disclosure of the present device and its embodiments, other components and means presently existing or later to be developed that perform substantially the same function to achieve substantially the same result as those of the corresponding embodiments described here, may be utilized according to the present application. Accordingly, the appended claims are intended to include within their scope such other components or means.

We claim:

1. A tube cutting and installation tool having a tool body including a handle portion and cutting portion, and the cutting portion includes a first tube open cutting head for cutting tube of a first tube size and a second tube open cutting head for cutting tube of a size different from the first tube size, each first and second tube open cutting head having a semi-circular configuration for receiving the engaging tube of the first tube size and second tube size within an internal circumference, respectively, and a trapezoidal knife blade removably positioned between the first and second tube open cutting heads so that a first blade tip of the trapezoidal knife blade extends into the internal circumference of the first tube open cutting head and a second blade tip of the trapezoidal knife blade extends into the internal circumference of the second tube open cutting head.

2. The tube cutting and installation tool of claim 1, wherein the handle portion of the tool body includes partial semi-circular configuration for engagement with a pipe nut during installation of a tube, and including a U-shaped cutout for engagement with a tab of the engaged pipe nut during installation of a tube.

3. The tube cutting and installation tool of claim 1, wherein the first tube open cutting head has a diameter sized for engagement with a first tube size of 1.25 inches.

4. The tube cutting and installation tool of claim 1, wherein the second tube open cutting head has a diameter sized for engagement with a second tube size of 1.50 inches.

5. The tube cutting and installation tool of claim 3, wherein the second tube open cutting head has a diameter sized for engagement with a second tube size of 1.50 inches.

6. The tube cutting and installation tool of claim 1, wherein the trapezoidal knife blade is removably positioned within the cutting portion by a blade cover plate engaged with the tool body to cover and trap the trapezoidal knife blade within the cutting portion of the tool body using conventional fasteners.

7. The tube cutting and installation tool of claim 1, wherein the cutting portion of the tool body further includes a U-shaped cutout exposing an intermediate section of the trapezoidal knife blade between the first and second blade tips.

8. The tube cutting and installation tool of claim 1, wherein the tool body includes a generally I-beam shaped cross-sectional configuration, and the semi-circular configuration of the first and second tube open cutting heads of the cutting portion of the tool body for receiving the engaging tube of the first tube size and second tube size has a wider cross portion of the I-beam than the opposite cross portion of the I-beam.

9. The tube cutting and installation tool of claim 1, further including a first rotating blade tip cover having an integral pin, where the first rotating blade tip cover is secured to the tool body by a hinged engagement of the integral pin with the tool body adjacent the first tube open cutting head for rotating the blade tip cover into engagement within the semi-circular configuration of the first tube open cutting head to cover the first blade tip of the trapezoidal knife blade when the cutting and installation tool is not cutting a tube.

10. The tube cutting and installation tool of claim 9, further including a second rotating blade tip cover having an integral pin, where the second rotating blade tip cover is secured to the tool body by a hinged engagement of the integral pin with the tool body adjacent the second tube open cutting head for rotating the blade tip cover into engagement within the semi-circular configuration of the second tube open cutting head to cover the second blade tip of the trapezoidal knife blade when the cutting and installation tool is not cutting a tube.
